(19) United States
(12) Patent Application Publication
(10) Pub. No.: US 2021/0250885 A1
(43) Pub. Date: Aug. 12, 2021

(54) Method And Apparatus For Timing And Frequency Synchronization In Non-Terrestrial Network Communications

(71) Applicant: MediaTek Singapore Pte. Ltd., Singapore (SG)

(72) Inventors: Abdelkader Medles, Cambridge (GB); Gilles Charbit, Cambridge (GB); Shiang-Jiun Lin, Hsinchu City (TW)

(21) Appl. No.: 17/145,392

(22) Filed: Jan. 10, 2021

Related U.S. Application Data
(60) Provisional application No. 62/972,087, filed on Feb. 10, 2020.

(51) Int. Cl. H04W 56/00; H04B 7/185; H04L 27/00

(52) U.S. Cl. CPC H04W 56/0015; H04W 56/0045; H04L 2027/0026; H04L 27/0014; H04B 7/18513

(57) ABSTRACT

Various solutions for timing and frequency synchronization in non-terrestrial network (NTN) communications with respect to user equipment and network nodes are described. An apparatus may receive a reference time signaled by a network node. The apparatus may measure a received time of a downlink message from the network node. The apparatus may estimate a propagation delay according to the reference time and the received time. The apparatus may perform a timing pre-compensation according to the propagation delay.

### CROSS REFERENCE TO RELATED PATENT APPLICATION(S)

The present disclosure is part of a non-provisional application claiming the priority benefit of U.S. Patent Application No. 62/972,087, filed on 10 Feb. 2020, the content of which being incorporated by reference in its entirety.

### TECHNICAL FIELD

The present disclosure is generally related to mobile communications and, more particularly, to timing and frequency synchronization in non-terrestrial network (NTN) communications with respect to user equipment and network nodes in mobile communications.

### BACKGROUND

Unless otherwise indicated herein, approaches described in this section are not prior art to the claims listed below and are not admitted as prior art by inclusion in this section.

A non-terrestrial network (NTN) refers to a network, or a segment of network(s), using radio frequency (RF) resources on board a satellite or an unmanned aircraft system (UAS) platform. A typical scenario of an NTN providing access to a user equipment (UE) involves either NTN transparent payload, with the satellite or UAS platform acting as a relay, or NTN regenerative payload, with a base station (e.g., gNB) on board the satellite or UAS platform.

In Long-Term Evolution (LTE) or New Radio (NR), a random access channel (RACH) procedure is introduced to establish a connection with and obtain resource from a network node. In the first step of the RACH procedure, the UE needs to transmit a RACH preamble signal (e.g., Message 1) to the network node. In NTN communication, the RACH procedure is also introduced to establish a connection with a satellite. However, for the NTN deployment, large differential delay and residual frequency offset within a beam may occur due to long transmission distances. There are some issues need to be overcome for the RACH procedure in NTN communication.

In satellite NTN deployment, time and frequency synchronisation are very challenging. For example, for Geosynchronous Equatorial Orbit (GEO) satellites, Sat-to-UE delay could be around 135 millisecond at 10° elevation with a differential delay of 16 millisecond. Maximum Doppler shift for Low Earth Orbit (LEO) satellites at 600 km altitude can be +/−48 kHz at 2 GHz carrier frequency. These extreme values of differential delay and Doppler shift are very challenging for UE synchronisation especially for initial access procedure.

One proposed way to deal with the synchronisation problem is to combine satellite position/reference Global Positioning System (GPS) time or another reference time knowledge through Global Navigation Satellite System (GNSS) capability. Satellite position may be derived according to satellite ephemeris broadcasted by the NTN network. Based on the information above, the UE can calculate the propagation delay and the Doppler shift and may be able to pre-compensate for them during the initial access procedure.

However, though the GNSS capability and satellite ephemeris for timing/frequency synchronization is possible, there are several problematics that may make it non robust or not always feasible. For example, the UE may not always be covered by enough GNSS satellites to derive an accurate UE position/time. The satellite ephemeris/position may not be accurately predictable. In case of Air to Ground (ATG) communication or High Altitude Platform Station (HAPS), the ephemeris or position of the base station/transmitter may not be signaled. The UE may sometimes loose GNSS coverage while maintaining or having access to an accurate GPS/reference timing. For a clock with +/−0.5 ppm accuracy available to the UE (+/−1 KHz@2 GHz), it will take 1000 seconds (˜17 minutes) for the timing to drift ˜0.5 millisecond. The GNSS/GPS dead time can save power by switching the GPS receiver off.

Accordingly, although the UE position may not be known or accurate enough, the UE can still use a relatively accurate clock or reference time for good enough timing/frequency synchronization for initial access. Therefore, there is a need to provide proper schemes for estimating Doppler offset and propagation delay with no positioning information and performing timing/frequency compensation/pre-compensation to achieve auto-synchronization in NTN communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to timing and frequency synchronization in NTN communications with respect to user equipment and network nodes in mobile communications.

In one aspect, a method may involve an apparatus receiving a reference time signaled by a network node. The method may also involve the apparatus measuring a received time of a downlink message from the network node. The method may further involve the apparatus estimating a propagation delay according to the reference time and the received time. The method may further involve the apparatus performing a timing pre-compensation according to the propagation delay.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a reference time signaled by the network node. The processor may also measure a received time of a downlink message from the network node. The processor may further estimate a propagation delay according to the reference time and the received time. The processor may further perform a timing pre-compensation according to the propagation delay.

Another objective of the present disclosure is to propose solutions or schemes that address the aforementioned issues pertaining to NTN-based UE positioning in NTN communications with respect to user equipment and network nodes in mobile communications.

In one aspect, a method may involve an apparatus receiving satellite information in a system information block (SIB) message from a network node. The method may also involve the apparatus estimating a position of the apparatus according to the satellite information. The method may further involve the apparatus performing, by the processor, a positioning according to the estimated position in case of absence of a GNSS coverage. The satellite information may comprise a reference time of a satellite and information about beam or cell location and coverage on ground.

In one aspect, an apparatus may comprise a transceiver which, during operation, wirelessly communicates with a plurality of UE of a wireless network. The apparatus may also comprise a processor communicatively coupled to the transceiver. The processor, during operation, may perform operations comprising receiving, via the transceiver, satellite information in a SIB message from a network node. The processor may also estimate a position of the apparatus according to the satellite information. The processor may further perform a positioning according to the estimated position in case of absence of a GNSS coverage. The satellite information may comprise a reference time of a satellite and information about beam or cell location and coverage on ground.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT), Narrow Band Internet of Things (NB-IoT), Industrial Internet of Things (IIoT) and non-terrestrial network (NTN), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example satellite communication scenario and an example general communication scenario under schemes in accordance with implementations of the present disclosure.

FIG. 2 is a diagram depicting an example satellite communication scenario and an example general communication scenario under schemes in accordance with implementations of the present disclosure.

FIG. 3 is a diagram depicting example satellite communication scenarios under schemes in accordance with implementations of the present disclosure.

FIG. 4 is a block diagram of an example communication apparatus and an example network apparatus in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to timing and frequency synchronization in NTN communications with respect to user equipment and network nodes in mobile communications. According to the present disclosure, a number of possible solutions may be implemented separately or jointly. That is, although these possible solutions may be described below separately, two or more of these possible solutions may be implemented in one combination or another.

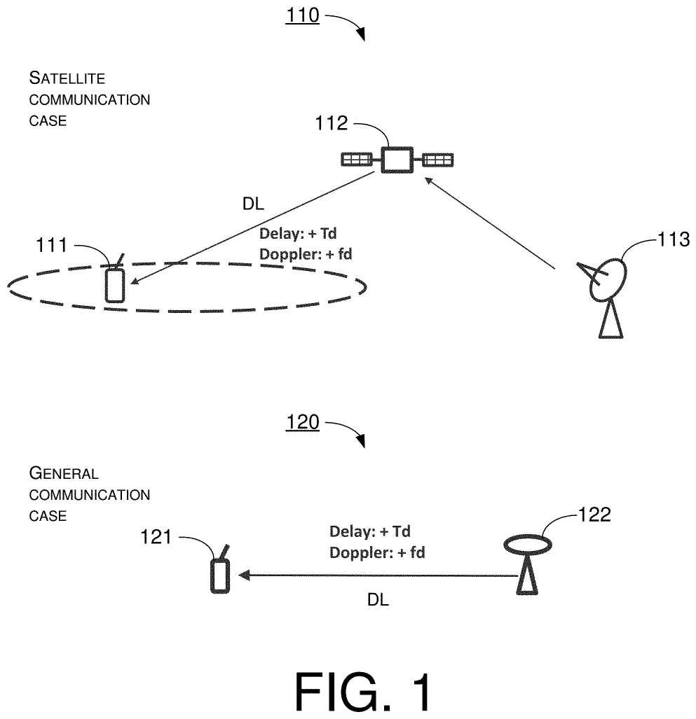

FIG. 1 illustrates example satellite communication scenario 110 and general communication scenario 120 under schemes in accordance with implementations of the present disclosure. Satellite communication scenario 110 involves UE 111, satellite 112 and base station 113, which may be a part of a wireless communication network (e.g., an LTE network, a 5G network, an NR network, an IoT network, an NB-IoT network, an IIoT network or an NTN network). UE 111 may be far from base station 113 (e.g., not within the communication range of base station 113) and not able to communicate with base station 113 directly. Via NTN, UE 111 may be able to transmit/receive signals to/from satellite 112. Satellite 112 may relay/transfer signals/data from UE 111 to base station 113. Thus, base station 113 may be able communicate with UE 111 via satellite 112. Since satellite 112 is far from UE 111, propagation delay in time domain (e.g., Td) and Doppler offset in frequency domain (e.g., fd) may be significant.

In contrast, general communication scenario 120 involves UE 121 and base station 122, which may be a part of a wireless communication network (e.g., an LTE network, a 5G network, an NR network, an IoT network, an NB-IoT network, an IIoT network or an NTN network). UE 121 is within the communication range of base station 122 and is able to communicate with base station 122 directly. Scenario 120 illustrates a general cellular network without involving a satellite. UE 121 can transmit/receive signals to/from base station 113 directly. There also exist propagation delay in time domain (e.g., Td) and Doppler offset in frequency domain (e.g., fd) between base station 122 and UE 121. Since UE 121 is not far from base station 122, the propagation delay and Doppler offset between UE 121 and base station 122 are relatively small.

In satellite NTN deployment, time and frequency synchronisation are very challenging. For example, for GEO satellites, Sat-to-UE delay could be around 135 millisecond at 10° elevation with a differential delay of 16 millisecond. Maximum Doppler shift for LEO satellites at 600 km altitude can be +/−48 kHz at 2 GHz carrier frequency. These extreme values of differential delay and Doppler shift are very challenging for UE synchronisation especially for initial access procedure.

One proposed way to deal with the synchronisation problem is to combine satellite position/reference GPS time or another reference time knowledge through GNSS capability. Satellite position may be derived according to satellite ephemeris broadcasted by the NTN network. Based on the information above, the UE can calculate the propagation delay and the Doppler shift and may be able to pre-compensate for them during the initial access procedure.

However, though the GNSS capability and satellite ephemeris for timing/frequency synchronization is possible, there are several problematics that may make it non robust or not always feasible. For example, the UE may not always be covered by enough GNSS satellites to derive an accurate UE position/time. The satellite ephemeris/position may not be accurately predictable. In case of Air to Ground (ATG) communication or High Altitude Platform Station (HAPS), the ephemeris or position of the base station/transmitter may not be signaled. The UE may sometimes loose GNSS coverage while maintaining or having access to an accurate GPS/reference timing. For a clock with +/−0.5 ppm accuracy available to the UE (+/−1 KHz@2 GHz), it will take 1000 seconds (˜17 minutes) for the timing to drift ˜0.5 millisecond. The GNSS/GPS dead time can save power by switching the GPS receiver off. Accordingly, although the UE position may not be known or accurate enough, the UE can still use a relatively accurate clock or reference time for good enough timing/frequency synchronization for initial access.

In view of the above, the present disclosure proposes a number of schemes pertaining to timing and frequency synchronization in NTN communications with respect to the UE and the network nodes. According to the schemes of the present disclosure, instead of using satellite ephemeris and GNSS capability or other means, the UE can have other means of auto-synchronisation and pre-compensation. The UE can have access to a reference time or clock which is accurate enough. Then the UE may be able to estimate the Doppler accurately enough and pre-compensate for it. The UE may also be able to estimate the propagation delay which potentially can include the circuitry delay and/or the gateway-to-sat delay in satellite communication and pre-compensate for it. Accordingly, by using accurate reference time or clock, the UE may still be able to achieve auto-synchronization by measuring and pre-compensating the propagation delay and Doppler shift between the UE and the satellite with no positioning information. The UE may be able to perform initial access procedure successfully and avoid lack of synchronization issues and transmission failure at the receiver side.

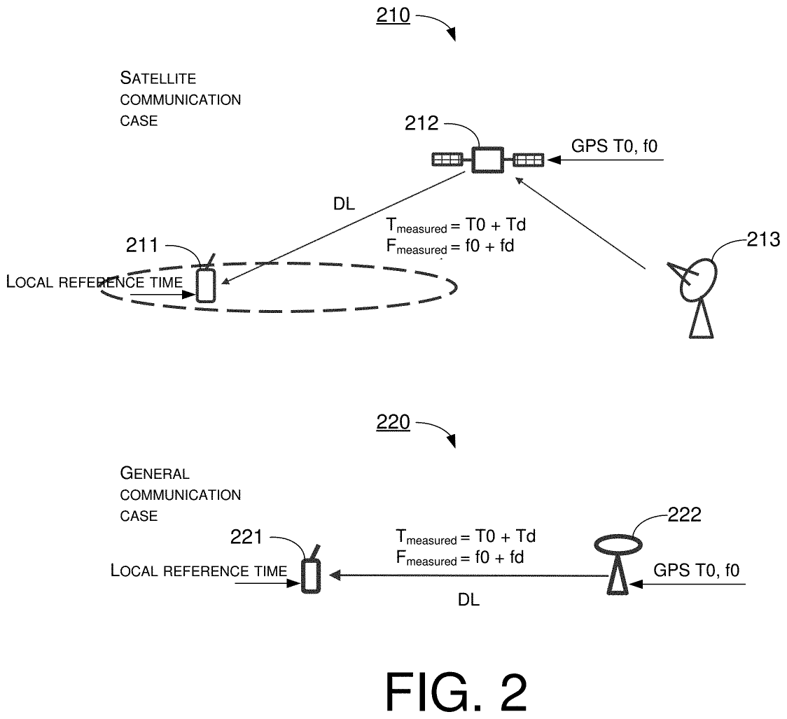

FIG. 2 illustrates example satellite communication scenario 210 and general communication scenario 220 under schemes in accordance with implementations of the present disclosure. Satellite communication scenario 210 involves UE 211, satellite 212 and base station 213, which may be a part of a wireless communication network (e.g., an LTE network, a 5G network, an NR network, an IoT network, an NB-IoT network, an IIoT network or an NTN network). UE 211 may be configured/equipped with UE auto-synchronisation capability. The UE may be able to receive a reference time signaled by a network node (e.g., satellite 212 or base station 213). The UE may measure a received time of a downlink message from the network node. The downlink message could be any messaged broadcasted or transmitted by the network node. The UE may estimate a propagation delay according to the reference time and the received time. Then, the UE may perform a timing pre-compensation according to the propagation delay.

For example, To may be the reference time signalled by the network node (e.g., satellite 212 or base station 213). It may correspond to timing associated with the transmission of a certain message (e.g. a system information block (SIB) message) or could be a new signalling/message used for NTN. The reference time may comprise at least one of an absolute time, a GPS time and a common reference time. The UE may further determine a measured receive time T_{measured} at the UE of the transmitted signal/message corresponding to T₀. Then, the UE may calculate the propagation delay T_{d} by T_{d}=T_{measured}−T₀. After determining the propagation delay T_{d}, the UE may be able to compensate/pre-compensate it and synchronize the timing with the network node.

In frequency domain, the UE may be configured to receive a reference carrier frequency signaled by the network node (e.g., satellite 212 or base station 213). The UE may measure a received carrier frequency from the network node. The UE may estimate a Doppler frequency offset according to the reference carrier frequency and the received carrier frequency. Then, the UE may perform a frequency pre-compensation according to the Doppler frequency offset.

For example, f_{0,ref} may be the reference carrier frequency (e.g., 2 GHz) signalled by the network node (e.g., satellite 212 or base station 213). The UE may generate a synchronized clock according to the reference time signaled by the network node. For example, the synchronized clock (e.g., f₀) may be the carrier frequency generated by the UE with auto-synchronization capability. The carrier frequency f₀ may be generated according to at least one of a very accurate crystal and a GNSS receiver clock in device. The UE may further determine a measured received carrier frequency f_{measured} at the UE. Then, the UE may calculate the Doppler frequency offset f_{Doppler} by f_{Doppler}=f_{measured}−f₀. After determining the Doppler frequency offset f_{Doppler}, the UE may be able to compensate/pre-compensate it and synchronize the frequency with the network node.

General communication scenario 220 involves UE 221 and base station 222, which may be a part of a wireless communication network (e.g., an LTE network, a 5G network, an NR network, an IoT network, an NB-IoT network, an IIoT network or an NTN network). Similarly, the auto-synchronization mechanism described above may also be applied to general communication scenario 220. The UE may be configured to receive a reference time signaled by a network node (e.g., base station 222). The UE may determine T₀ and f₀ according to the reference time signaled by the network node. The UE may be configured to calculate the propagation delay T_{d} by T_{d}=T_{measured}−T₀ and the Doppler frequency offset f_{Doppler} by f_{Doppler}=f_{measured}−f₀. Then, the UE may be able to compensate/pre-compensate the propagation delay T_{d} and the Doppler frequency offset f_{Doppler} and synchronize the timing and frequency with the network node.

In some implementations, the timing and/or clock used by the UE may be calibrated to the reference time signaled by the network node (e.g., GPS time or other common reference time with the satellite) during the GNSS reception time. The GNSS dead time is due to interruption of GNSS reception, either for lack of GNSS coverage or as a power saving measure, or when the UE can only operate in a single mode (e.g., NTN mode or GPS mode). During GNSS dead time, the clock at the UE may be kept calibrated by calculating the satellite Doppler Effect from ephemeris and comparing it to the estimated Doppler to correct the clock accordingly. For example, the UE may be configured to generate a synchronized clock and keep the synchronized clock accurate by using a satellite ephemeris and an approximate position.

In some implementations, the reference time used by the UE may comprise a local accurate time clock within the UE or provided by a local network (e.g., a local reference time). For a clock with +/−0.5 ppm accuracy available to the UE (+/−1 KHz@2 GHz), it will take 1000 seconds (˜17 minutes) for the timing to drift ˜0.5 millisecond. In typical DRX time<10 seconds, the timing drift could be of the order of <5 microseconds (i.e., within a fraction of a cyclic prefix). The UE may correct even more accurately the clock based on the difference between the estimated receive frequency on one hand and the centre carrier frequency plus the Satellite Doppler as predicted by the satellite ephemeris on the other hand. Such a method allows the UE to maintain a very accurate and calibrated clock but may require a rough knowledge of the UE position.

In some implementations, link to satellite or other network may provide an accurate clock but not necessarily the position. For example, a timestamp can be included in satellite SIB to allow UE to estimate propagation delay and remove/compensate it from satellite clock reference. The UE may use the accurate clock and the reference time from the satellite/base station to estimate the Doppler frequency offset and the propagation delay.

In some implementations, the auto-synchronisation capability would work similar to GNSS capability in terms of compensation. However, the UE may not have the positioning capability. Absence of positioning capability may limit the capability to predict neighbouring satellite or next beam trajectory in case of satellite communication or limit the ability of the UE to report an accurate position to the core network. Therefore, signalling the use of time reference for auto-synchronization instead of GNSS/positioning capability would be needed. Thus, the UE may transmit a capability report to indicate a pre-compensation capability to the network node. For example, the UE may signal its capability in terms of a synchronisation capability (with no simultaneous accurate positioning) and/or a positioning capability. Such capability may also be instead named as a pre-compensation capability. The use of the auto-synchronisation capability/pre-compensation capability does not require the base station position or the satellite ephemeris signalling. The pre-compensation capability may be made independent of GNSS/positioning capability and may be signalled independently.

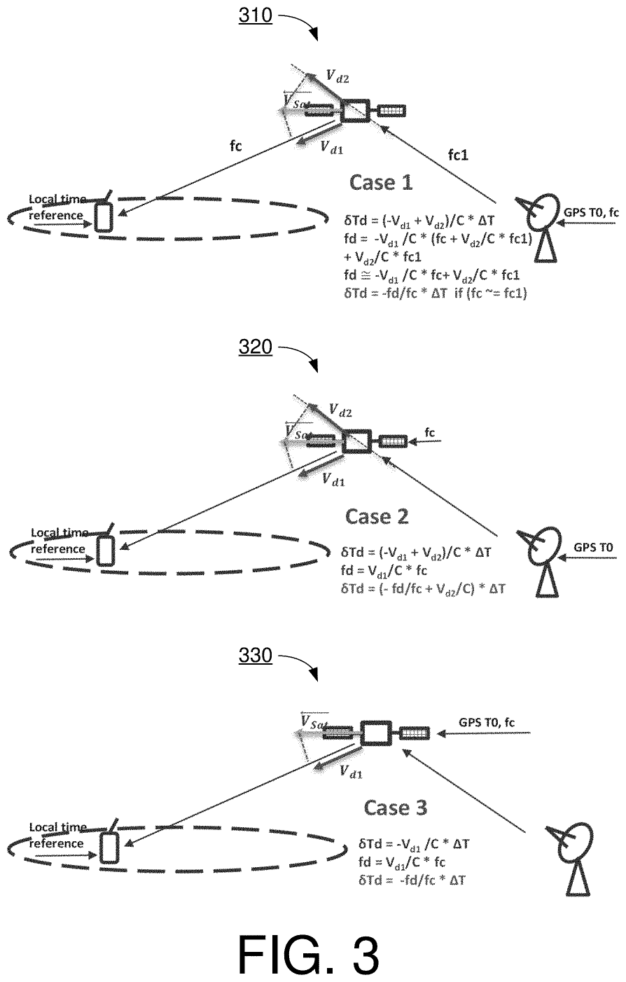

In some implementations, the NTN network may need to signal to the UE or clarify in the 3^{rd} Generation Partnership Project (3GPP) specifications at which node in the transmission chain does the time reference and carrier frequency correspond to or generated in case of satellite communication. FIG. 3 illustrates example satellite communication scenarios 310, 320 and 330 under schemes in accordance with implementations of the present disclosure. Satellite communication scenarios 310, 320 and 330 may involve a UE, a satellite and a base station/gateway, which may be a part of a wireless communication network (e.g., an LTE network, a 5G network, an NR network, an IoT network, an NB-IoT network, an IIoT network or an NTN network). The gateway may be a network node within the core network and may be at the same ground location with the base station. In scenario 310, the time/frequency reference point is at the gateway (e.g., gateway-to-satellite Doppler is corrected at satellite). The Doppler frequency and the propagation delay rate of change may not be directly proportional. The propagation delay rate of change may also depend on the location of the gateway/ground station and the gateway-to-satellite frequency (e.g., fc1).

In scenario 320, the time reference point is at the gateway (e.g., gateway-to-satellite Doppler is corrected at satellite). The Doppler frequency and the propagation delay rate of change may not be directly proportional. The propagation delay rate of change may also depend on the location of the gateway/ground station and the gateway-to-satellite frequency. In scenario 330, the time/frequency reference point is at the satellite/antenna port (e.g., gateway-to-satellite Doppler and propagation delay is corrected at satellite). The Doppler frequency and the propagation delay rate of change will be directly proportional.

In some implementations, the NTN network may need to clarify/indicate where the frame reference timing and/or the frequency point corresponds to in case of the satellite communication. For example, the time and frequency reference point could be the gateway. In another example, the time and frequency reference point could be the satellite. In another example, the time reference point could be the Gateway, but the frequency reference point could be the satellite.

In some implementations, the UE may be configured to receive a signaling from the network node to indicate a time and frequency reference point. The time and frequency reference point may comprise the satellite or the gateway.

In some implementations, the UE may be configured to receive a signaling from the network node to indicate a distance where the timing pre-compensation and the frequency pre-compensation need to be performed. The distance may comprise a first distance between the apparatus and a satellite and a second distance between the apparatus and a gateway.

In some implementations, to improve timing and frequency compensation estimation, some or all of the additional information may be needed especially in case of one or both of the time/frequency is generated at the gateway. The additional information may comprise, for example and without limitations, at least one of a ground station/gateway location, an additional time delay due to switching, a satellite ephemeris and a gateway-to-satellite carrier frequency. The UE may be configured to receive the additional information from the network node and perform the timing pre-compensation and the frequency pre-compensation according to the additional information.

In some implementations, to improve UE positioning, one way is for the UE to use satellite information to estimate or improve the estimation of its position. This may improve the UE position estimation in case of absence or weak GNSS coverage or allow shorter GNSS measurement/convergence time for position with required accuracy. To realize such proposal, in addition to satellite ephemeris (e.g., in case of satellite communication), part or all of the following information may be signalled to the UE in a SIB message. For example, a reference time (e.g., GPS time and satellite time) may be signalled to the UE for improving the UE positioning. In another example, the information about beam location on the ground may be used by the UE for improving the UE positioning. For satellite communication, the information about beam location on the ground may be determined according to at least one of a beam layout, a coordinate for centre of beam and its size, an antenna beam angles, an antenna aperture, a ground station/gateway location and an additional time delay due to switching. The ground station location and additional time delay due to switching signaling may be especially needed in an event that the gateway-to-satellite propagation delay and switching time (e.g., due to radio frequency (RF) front end and circuitry) is not compensated. For ATG/NAPS communication, the information about beam location on the ground may be determined according to at least one of a cell/beam centre coordinate, a cell/beam size, an antenna beam angles and an antenna aperture.

Accordingly, to improve NTN-based UE positioning, the UE may be configured to receive satellite information in a SIB message from a network node (e.g., a satellite). The UE may estimate its position according to the satellite information. The UE may perform a positioning functionality according to the estimated position in case of absence of a GNSS coverage. The satellite information may comprise reference time of a satellite and information about beam or cell location and coverage on ground.

### Illustrative Implementations

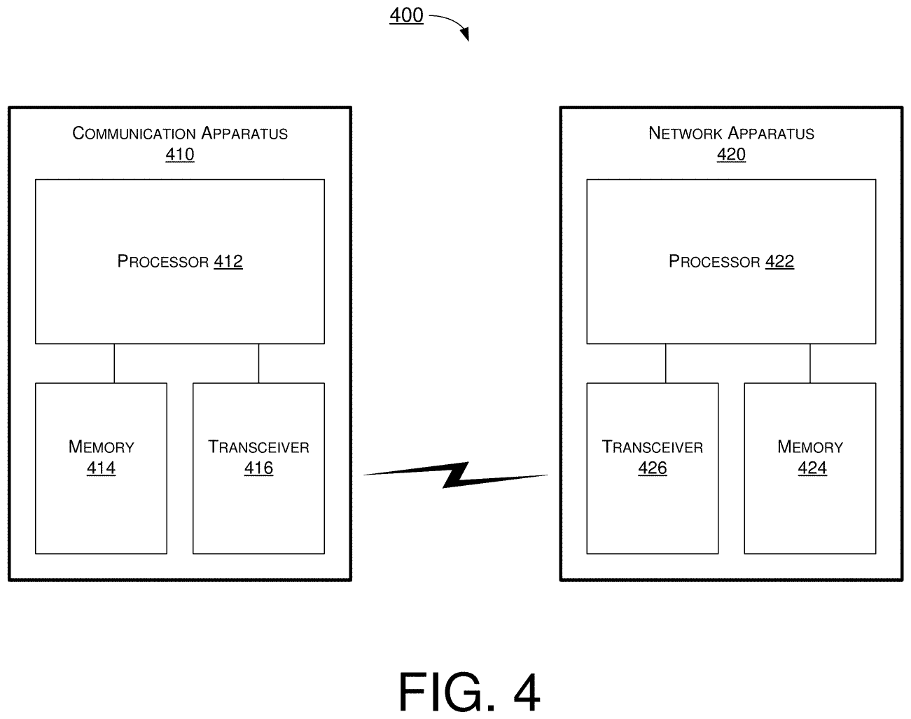

FIG. 4 illustrates an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to timing and frequency synchronization in NTN communications with respect to user equipment and network apparatus in wireless communications, including scenarios/schemes described above as well as processes 500 and 600 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus/station, which may be a network node such as a base station, a small cell, a router, a gateway or a satellite. For instance, network apparatus 420 may be implemented in an eNodeB in an LTE, in a gNB in a 5G, NR, IoT, NB-IoT, IIoT, or in a satellite in an NTN network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including power consumption reduction in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, communication apparatus 410 may be configured/equipped with auto-synchronisation capability. Processor 412 may be able to receive, via transceiver 416, a reference time signaled by network apparatus 420. Processor 412 may measure a received time of a downlink message from network apparatus 420. Processor 412 may estimate a propagation delay according to the reference time and the received time. Then, processor 412 may perform a timing pre-compensation according to the propagation delay. The reference time may comprise at least one of an absolute time, a GPS time and a common reference time.

In some implementations, processor 412 may be configured to receive, via transceiver 416, a reference carrier frequency signaled by network apparatus 420. Processor 412 may measure a received carrier frequency from network apparatus 420. Processor 412 may estimate a Doppler frequency offset according to the reference carrier frequency and the received carrier frequency. Then, processor 412 may perform a frequency pre-compensation according to the Doppler frequency offset.

In some implementations, processor 412 may be configured to generate a synchronized clock according to the reference time signaled by network apparatus 420. Processor 412 may keep the synchronized clock accurate by using a satellite ephemeris and an approximate position.

In some implementations, processor 412 may be configured to receive, via transceiver 416, a signaling from network apparatus 420 to indicate a time and frequency reference point. The time and frequency reference point may comprise the satellite or the gateway.

In some implementations, processor 412 may transmit, via transceiver 416, a capability report to indicate a pre-compensation capability to network apparatus 420. For example, processor 412 may signal its capability in terms of a synchronisation capability (with no simultaneous accurate positioning) and/or a positioning capability. Such capability may also be instead named as a pre-compensation capability.

In some implementations, network apparatus 420 may need to signal to communication apparatus 410 at which node in the transmission chain does the time reference and carrier frequency correspond to or generated in case of satellite communication. Processor 412 may be configured to receive, via transceiver 416, a signaling from network apparatus 420 to indicate a time and frequency reference point. The time and frequency reference point may comprise the satellite or the gateway.

In some implementations, processor 412 may be configured to receive, via transceiver 416, a signaling from network apparatus 420 to indicate a distance where the timing pre-compensation and the frequency pre-compensation need to be performed. The distance may comprise a first distance between the apparatus and a satellite and a second distance between the apparatus and a gateway.

In some implementations, to improve timing and frequency compensation estimation, some or all of the additional information may be needed especially in case of one or both of the time/frequency is generated at the gateway. The additional information may comprise, for example and without limitations, at least one of a ground station/gateway location, an additional time delay due to switching, a satellite ephemeris and a gateway-to-satellite carrier frequency. Processor 412 may be configured to receive, via transceiver 416, the additional information from network apparatus 420 and perform the timing pre-compensation and the frequency pre-compensation according to the additional information.

In some implementations, processor 412 may be configured to receive, via transceiver 416, satellite information in a SIB message from network apparatus 420. Processor 412 may estimate its position according to the satellite information. Processor 412 may perform a positioning functionality according to the estimated position in case of absence of a GNSS coverage. The satellite information may comprise reference time of a satellite and information about beam or cell location and coverage on ground. The information about beam or cell location and coverage on ground may comprise at least one of a beam layout, a coordinate of beam or cell center, a size of beam or cell, an antenna beam angle, an antenna aperture, a ground station location, and an additional time delay due to switching.

### Illustrative Processes

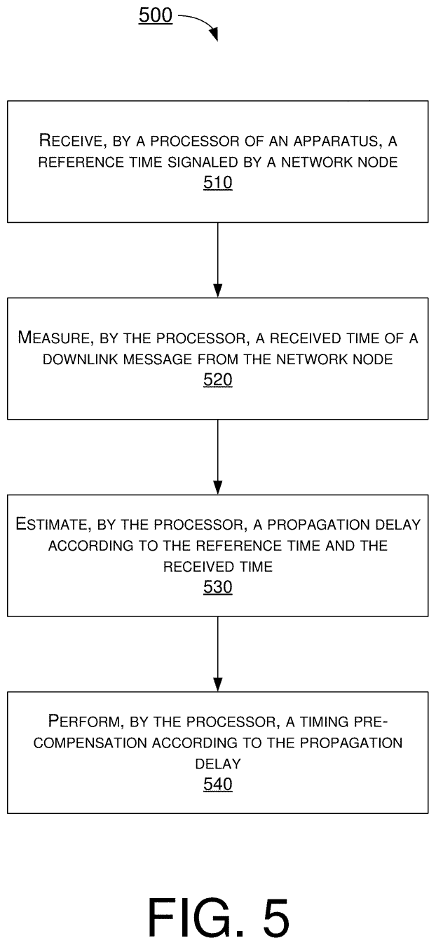

FIG. 5 illustrates an example process 500 in accordance with an implementation of the present disclosure. Process 500 may be an example implementation of schemes described above, whether partially or completely, with respect to timing and frequency synchronization in NTN communications with the present disclosure. Process 500 may represent an aspect of implementation of features of communication apparatus 410. Process 500 may include one or more operations, actions, or functions as illustrated by one or more of blocks 510, 520, 530 and 540. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At 510, process 500 may involve processor 412 of apparatus 410 receiving a reference time signaled by a network node. Process 500 may proceed from 510 to 520.

At 520, process 500 may involve processor 412 measuring a received time of a downlink message from the network node. Process 500 may proceed from 520 to 530.

At 530, process 500 may involve processor 412 estimating a propagation delay according to the reference time and the received time. Process 500 may proceed from 530 to 540.

At 540, process 500 may involve processor 412 performing a timing pre-compensation according to the propagation delay.

In some implementations, process 500 may involve processor 412 receiving a reference carrier frequency signaled by the network node. Process 500 may also involve processor 412 measuring a received carrier frequency from the network node. Process 500 may further involve processor 412 estimating a Doppler frequency offset according to the reference carrier frequency and the received carrier frequency. Then, process 500 may involve processor 412 performing a frequency pre-compensation according to the Doppler frequency offset.

In some implementations, the reference time may comprise at least one of an absolute time, a GPS time, and a common reference time.

In some implementations, process 500 may involve processor 412 generating a synchronized clock according to the reference time signaled by the network node.

In some implementations, process 500 may involve processor 412 keeping the synchronized clock accurate by using a satellite ephemeris and an approximate position.

In some implementations, process 500 may involve processor 412 transmitting a capability report to indicate a pre-compensation capability to the network node.

In some implementations, process 500 may involve processor 412 receiving a signaling from the network node to indicate a time and frequency reference point. The time and frequency reference point may comprise a satellite or a gateway.

In some implementations, process 500 may involve processor 412 receiving a signaling from the network node to indicate a distance where the timing pre-compensation and the frequency pre-compensation need to be performed. The distance may comprise a first distance between the apparatus and a satellite or a second distance between the apparatus and a gateway.

In some implementations, process 500 may involve processor 412 receiving additional information from the network node. Process 500 may further involve processor 412 performing the timing pre-compensation and the frequency pre-compensation according to the additional information. The additional information may comprise at least one of a ground station location, a satellite ephemeris, and a gateway-to-satellite carrier frequency.

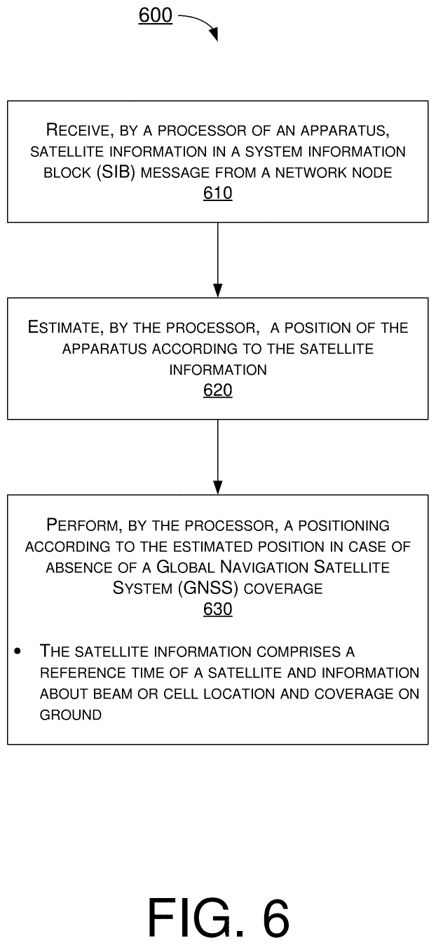

FIG. 6 illustrates an example process 600 in accordance with an implementation of the present disclosure. Process 600 may be an example implementation of schemes described above, whether partially or completely, with respect to NTN-based UE positioning in NTN communications with the present disclosure. Process 600 may represent an aspect of implementation of features of communication apparatus 410. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks of process 500 may executed in the order shown in FIG. 6 or, alternatively, in a different order. Process 600 may be implemented by communication apparatus 410 or any suitable UE or machine type devices. Solely for illustrative purposes and without limitation, process 600 is described below in the context of communication apparatus 410. Process 600 may begin at block 610.

At 610, process 600 may involve processor 412 of apparatus 410 receiving satellite information in a SIB message from a network node. Process 600 may proceed from 610 to 620.

At 620, process 600 may involve processor 412 estimating a position of the apparatus according to the satellite information. Process 600 may proceed from 620 to 630.

At 630, process 600 may involve processor 412 performing a positioning according to the estimated position in case of absence of a GNSS coverage. The satellite information may comprise a reference time of a satellite and information about beam or cell location and coverage on ground.

In some implementations, the information about beam or cell location and coverage on ground may comprise at least one of a beam layout, a coordinate of beam or cell center, a size of beam or cell, an antenna beam angle, an antenna aperture, a ground station location, and an additional time delay due to switching.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a reference time signaled by a network node;
measuring, by the processor, a received time of a downlink message from the network node;
estimating, by the processor, a propagation delay according to the reference time and the received time; and
performing, by the processor, a timing pre-compensation according to the propagation delay.

2. The method of claim 1, further comprising:
receiving, by the processor, a reference carrier frequency signaled by the network node;
measuring, by the processor, a received carrier frequency from the network node;
estimating, by the processor, a Doppler frequency offset according to the reference carrier frequency and the received carrier frequency; and
performing, by the processor, a frequency pre-compensation according to the Doppler frequency offset.

3. The method of claim 1, wherein the reference time comprises at least one of an absolute time, a Global Positioning System (GPS) time, and a common reference time.

4. The method of claim 1, further comprising:
generating, by the processor, a synchronized clock according to the reference time signaled by the network node.

5. The method of claim 4, further comprising:
keeping, by the processor, the synchronized clock accurate by using a satellite ephemeris and an approximate position.

6. The method of claim 2, further comprising:
transmitting, by the processor, a capability report to indicate a pre-compensation capability to the network node.

7. The method of claim 2, further comprising:
receiving, by the processor, a signaling from the network node to indicate a time and frequency reference point,
wherein the time and frequency reference point comprises a satellite or a gateway.

8. The method of claim 2, further comprising:
receiving, by the processor, a signaling from the network node to indicate a distance where the timing pre-compensation and the frequency pre-compensation need to be performed,
wherein the distance comprises a first distance between the apparatus and a satellite or a second distance between the apparatus and a gateway.

9. The method of claim 2, further comprising:
receiving, by the processor, additional information from the network node; and
performing, by the processor, the timing pre-compensation and the frequency pre-compensation according to the additional information,
wherein the additional information comprises at least one of a ground station location, a satellite ephemeris, and a gateway-to-satellite carrier frequency.

10. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a reference time signaled by the network node;
measuring a received time of a downlink message from the network node;
estimating a propagation delay according to the reference time and the received time; and
performing a timing pre-compensation according to the propagation delay.

11. The apparatus of claim 10, wherein, during operation, the processor further performs operations comprising:
receiving, via the transceiver, a reference carrier frequency signaled by the network node;
measuring a received carrier frequency from the network node;
estimating a Doppler frequency offset according to the reference carrier frequency and the received carrier frequency; and
performing a frequency pre-compensation according to the Doppler frequency offset.

12. The apparatus of claim 10, wherein the reference time comprises at least one of an absolute time, a Global Positioning System (GPS) time, and a common reference time.

13. The apparatus of claim 10, wherein, during operation, the processor further performs operations comprising:
generating a synchronized clock according to the reference time signaled by the network node.

14. The apparatus of claim 13, wherein, during operation, the processor further performs operations comprising:
keeping the synchronized clock accurate by using a satellite ephemeris and an approximate position.

15. The apparatus of claim 11, wherein, during operation, the processor further performs operations comprising:
transmitting, via the transceiver, a capability report to indicate a pre-compensation capability to the network node.

16. The apparatus of claim 11, wherein, during operation, the processor further performs operations comprising:
receiving, via the transceiver, a signaling from the network node to indicate a time and frequency reference point,
wherein the time and frequency reference point comprises a satellite or a gateway.

17. The apparatus of claim 11, wherein, during operation, the processor further performs operations comprising:
receiving, via the transceiver, a signaling from the network node to indicate a distance where the timing pre-compensation and the frequency pre-compensation need to be performed,
wherein the distance comprises a first distance between the apparatus and a satellite or a second distance between the apparatus and a gateway.

18. The apparatus of claim 11, wherein, during operation, the processor further performs operations comprising:
receiving, via the transceiver, additional information from the network node; and
performing the timing pre-compensation and the frequency pre-compensation according to the additional information,
wherein the additional information comprises at least one of a ground station location, a satellite ephemeris, and a gateway-to-satellite carrier frequency.

19. A method, comprising:
receiving, by a processor of an apparatus, satellite information in a system information block (SIB) message from a network node; and
estimating, by the processor, a position of the apparatus according to the satellite information; and
performing, by the processor, a positioning according to the estimated position in case of absence of a Global Navigation Satellite System (GNSS) coverage,
wherein the satellite information comprises a reference time of a satellite and information about beam or cell location and coverage on ground.

20. The method of claim 19, wherein the information about beam or cell location and coverage on ground comprises at least one of a beam layout, a coordinate of beam or cell center, a size of beam or cell, an antenna beam angle, an antenna aperture, a ground station location, and an additional time delay due to switching.
